(19) United States
(12) Patent Application Publication
(10) Pub. No.: US 2002/0121822 A1
(43) Pub. Date: Sep. 5, 2002

(54) Stabilizing battery

(76) Inventor: Steven Mark Jones, Mason, NH (US)

Correspondence Address: Steven Mark Jones, 346 Old Ashby Road, Mason, NH, 03048, US

(21) Appl. No.: 10/080,030

(22) Filed: Feb. 21, 2002

Related U.S. Application Data
(60) Provisional application No. 60/270,478, filed on Feb. 21, 2001.

(51) Int. Cl. B60K 1/00; H02K 7/02; G05G 1/00

(52) U.S. Cl. 310/74; 180/65.2; 74/572

(57) ABSTRACT

A mechanical storage battery which includes, a battery housing (16) with all its internals, there is a central computer (14) that monitors and controls the Stabilizing Battery, there is also a throttle positioning sensor that activates and de-actives the motor/generator which is connected to the internal combustion engine (ICE) when add ional power output is required to assist the hybrid motor vehicle. Built into the central computer (14) housing there is a gyroscope (13) with its sensors are directly connected to the central computer (14). The central computer (14) monitors the sideways angle and the acceleration of the sideways angle of the of the motor vehicle. When the motor vehicle passes the acceptable level of lean and a roll over is about to happen, then the central computer (14) strategically informs the stators (12) which are placed 45 degrees off center of the movable rotors, how to function. Some of the stators (12) function like a generator and some of the stators function like a motor. With the stators (12) being independently activated by the central computer (14) and the movable weights (2) within the movable rotors (1), produces a torque action on the motor vehicle. Depending in which direction the motor vehicle is about to roll over, the Stabilizing Battery know from its built in sensors and will produce an opposite torque action on the motor vehicle, keeping all the wheels on the ground preventing a roll over, increasing the stability and control. When the motor vehicle has fully stabilized the gyroscope (13) will inform the central computer (14) and the central computer (14) informs all the stators (12) to stop functioning like an anti-roll system and start functioning like a mechanical battery once again until the next time an anti-roll system is needed.

### CROSS-REFERENCE TO RELATED APPLICATIONS

The present application is based on claims the benefit of U.S. Provisional Patent Application, Entitled “Stabilizing Battery and Stabilizing Generator” Serial No. 60/270,478 Filing Date Feb. 21, 2001

### BACKGROUND OF THE INVENTION

The future hybrid motor vehicles are the reason this battery was invented, because of the growing demand for fuel efficient motor vehicles to compensate for high fuel cost and tightening of EPA regulations on emissions of new vehicles. To achieve less emissions on any giving vehicle, first start with a smaller than normally required internal combustion engine (ICE).

When the hybrid vehicle needs a greater power output than the small ICE can deliver an electric motor/generator kicks in functioning like a motor, assisting the small ICE. This partially depletes the battery that powers the electric motor/generator.

When the motor vehicle goes back to a low power requirement, the motor/generator functions like a generator and recharges the battery back to full capacity. Then the system is ready for the next time there is a demand for a high power output. This is a very efficient way to operate a motor vehicle.

The main problem with this modern approach of hybrid motor vehicle propulsion is the chemical battery. Theses batteries have multiple problems that should be examined before automobile manufacturers can mass produce hybrid motor vehicles.

First, there is the limited cycles that the lead acid battery can be put through before they have to be replaced.

Second, there are nickel-iron, zinc-iron, sodium-sulfur and lithium-iron sulfide batteries that offer a much higher cycle rate at a higher cost but still need replacement. Also, when these batteries start to wear out they offer only a limited amount of electrical power storage capacity compared to a new battery.

Third, is the electrical power storage capacity at different ambient temperatures. The colder the battery becomes, the less electrical power storage capacity a chemical battery has.

Fourth, there is the environmental problem, if lead acid batteries are used they are cheap but need to be replaced frequently, when using nickel-iron, zinc-iron, sodium-sulfur and lithium-iron sulfide batteries they last longer but are made of very hazardous materials.

Fifth, there are other mechanical batteries on the market but they are not properly designed or suited for motor vehicles, they have small diameter one piece flywheels spun at very high speeds, they use magnetic bearings which increases there overall efficiency. They are very expensive, the magnetic bearings are half the cost of the battery, plus they have problems handling and controlling the gyroscopic forces produced from the high speed one piece flywheels.

Sixth, future sport utility vehicles are the next likely candidate for hybrid propulsion to reduce there high fuel consumption, but they have a high center of gravity which promotes roll-overs.

### BRIEF SUMMARY OF THE INVENTION

The Stabilizing Battery is a very unique electrical power storage unit, that was specially designed but not limited for motor vehicle use.

First, the Stabilizing Battery was designed to last the operating life of the motor vehicle.

Second, the Stabilizing Battery offers the same electrical power capacity though it's entire service life.

Third, the Stabilizing Battery's electrical storage capacity is not effected by the variations in the ambient temperature.

Forth, there is no environmental problem because the Stabilizing Battery has no hazardous material inside.

Fifth, the Stabilizing Battery substantially reduces the gyroscopic forces to the motor vehicle by use of a movable rotor design. Which flexes as the motor vehicle moves side to side or up and down or both.

Sixth, the Stabilizing Battery features a novel anti-roll system built in which would be very useful in high center of gravity vehicles.

Seventh, the Stabilizing Battery can also be used as an anti-roll system for tractor trailer trucks, to produce proper stabilization on and the off the exits ramps increasing safety and reducing accidents.

### BRIEF DESCRIPTIONS OF DRAWINGS

The various objects, advantages and novel features of this invention are more fully apparent from a reading of the detailed description in conjunction with the accompanying drawings in which like reference numerals refer to like parts, and in which:

FIG. 1A: Is a top view of the internals of the Stabilizing Battery;

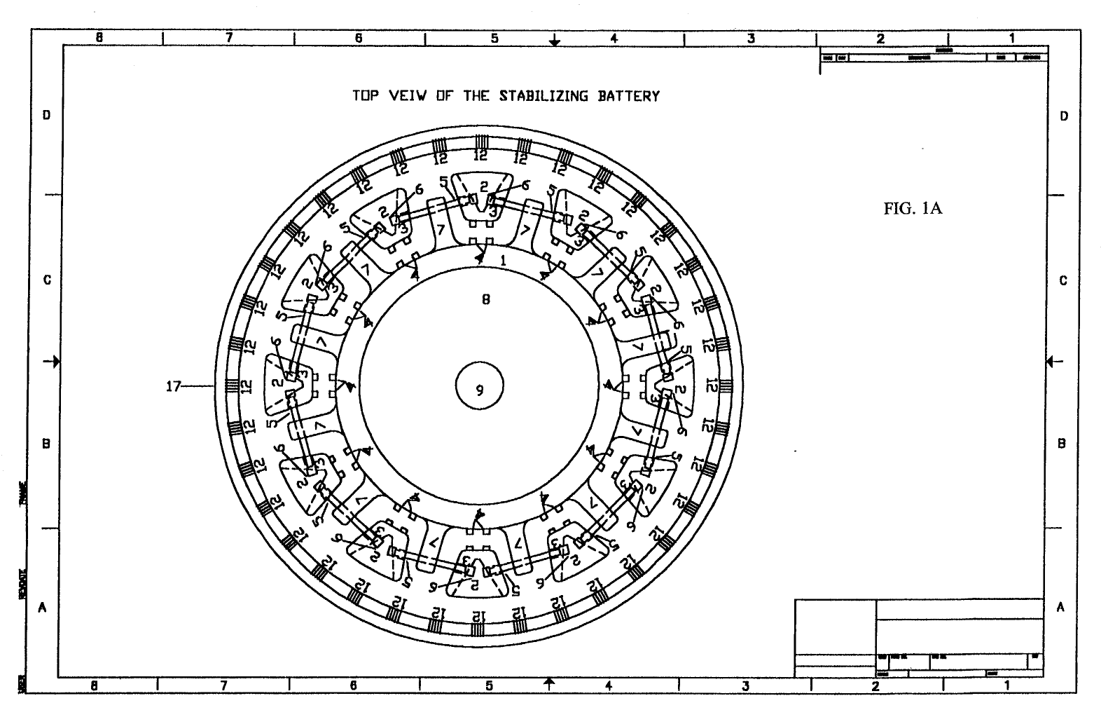

FIG. 2A: Is the cross-sectional view of the internals of the Stabilizing Battery;

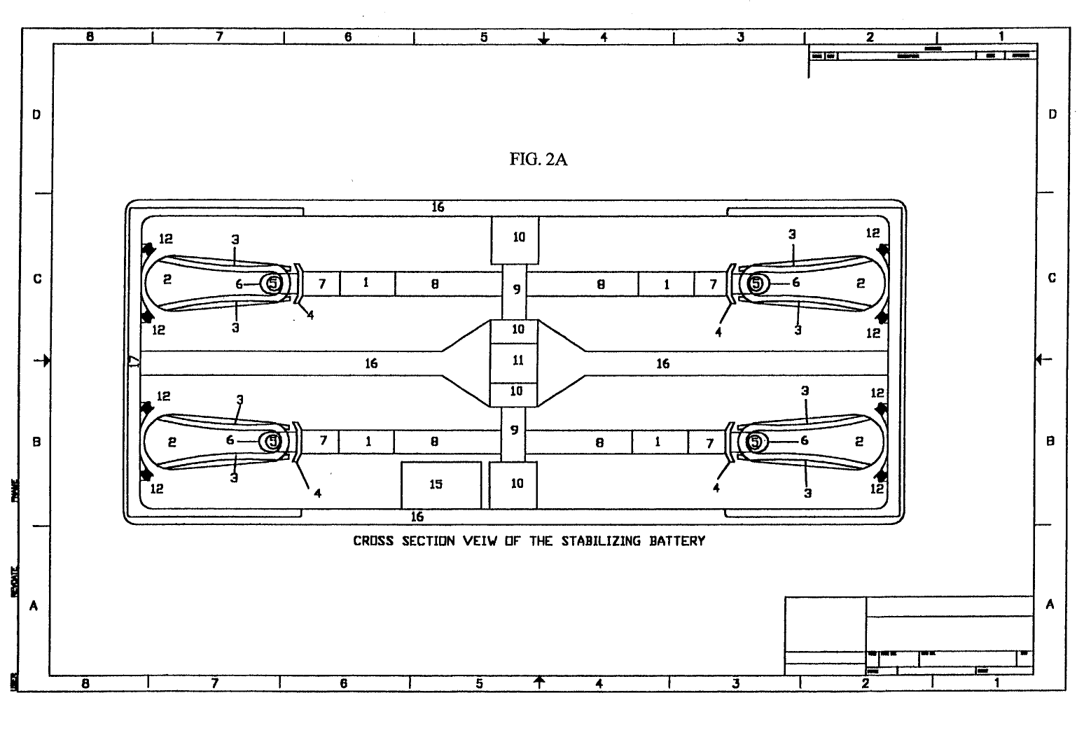

FIG. 3A: Is a front view of the movable weights facing the stators, each side of the movable weight, having a magnet with four poles at each end of the magnet, 8 poles total per magnet;

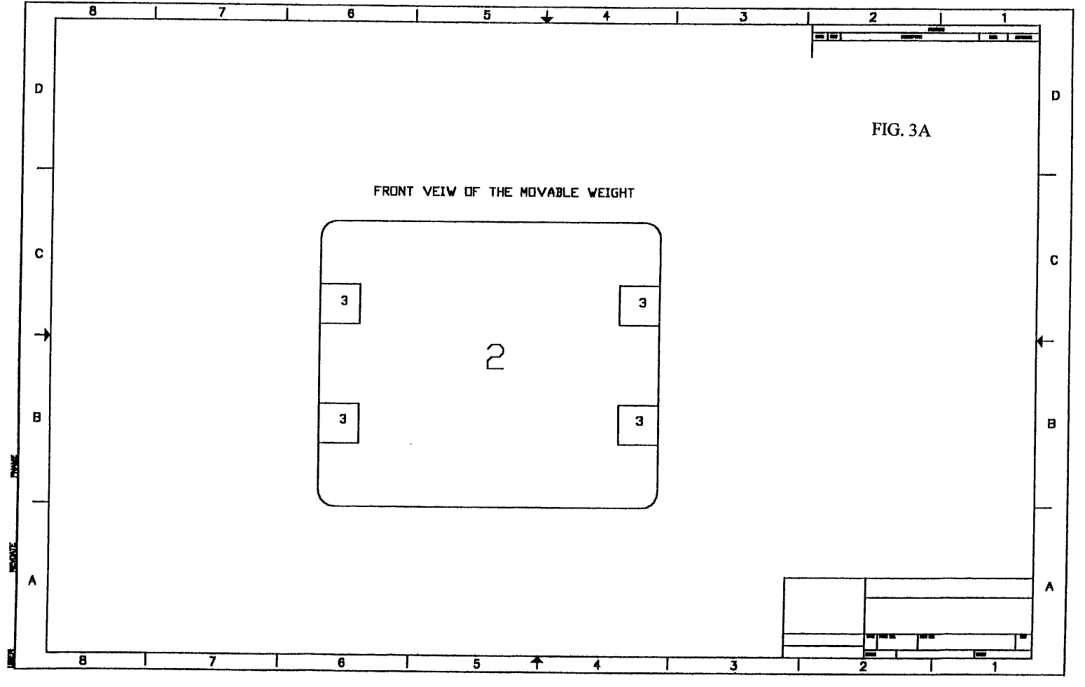

FIG. 4A: Is a top view of a gyroscope positioned adjacent to a Stabilizing Battery central computer;

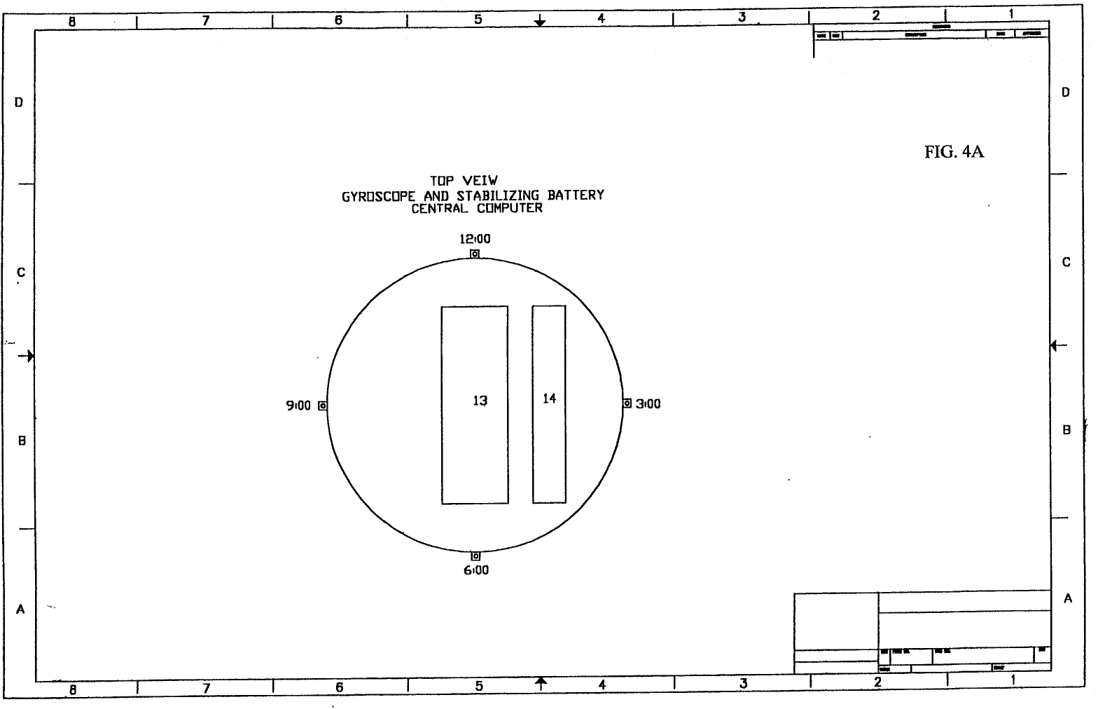

FIG. 5A: Is the top external view of the Stabilizing Battery housing with its 4 mounting positions;

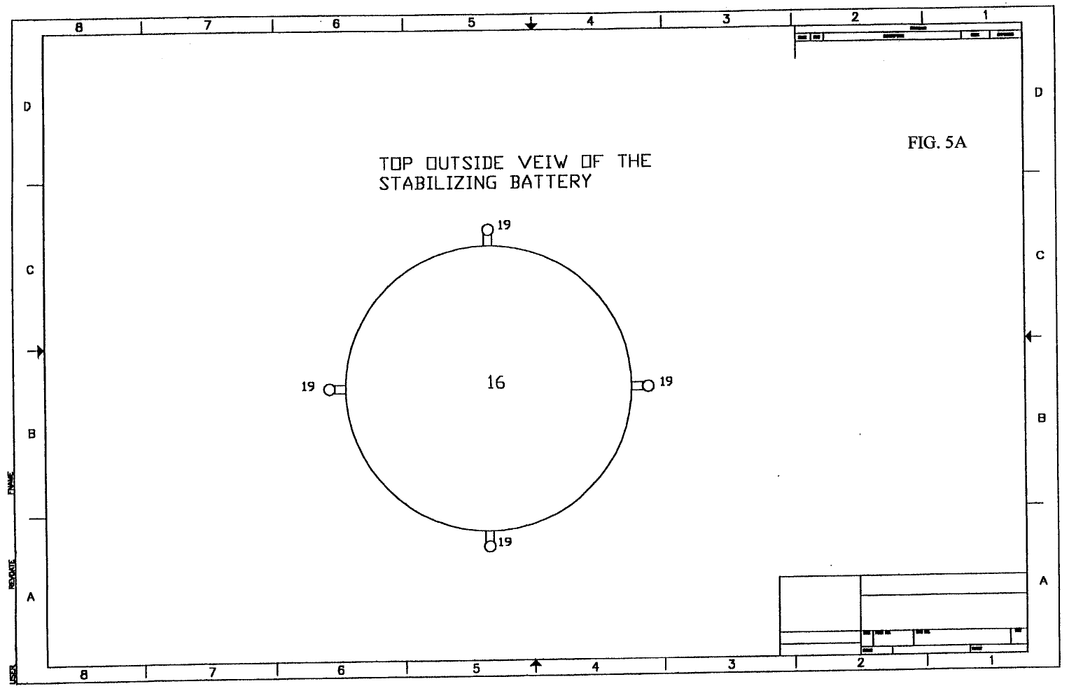

FIG. 6A: Is a side view of a throttle positioning sensor;

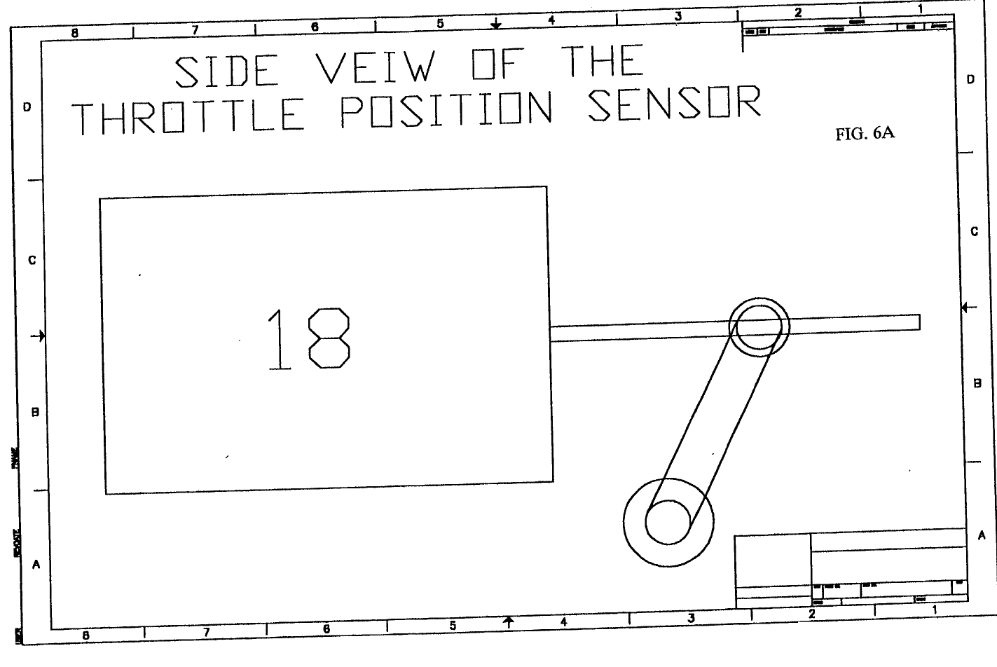

### DETAILED DESCRIPTION OF THE INVENTION

### Operation of the Stabilizing Battery

When the motor vehicle is started the central computer (14) informs all eight stators (12) to be energized and function like a motor. The electrical input to the eight said stators (12) come from the electrical output from the motor/generator connected to the internal combustion engine (ICE) which is functioning like a generator.

If a faster start is required, the Stabilizing Battery can be fitted with high capacity capacitors, which would increase the price. The two identical movable rotors (1) will now start spinning in the opposite directions, canceling the torque from each other and eliminating twist on the said motor vehicle.

The two said movable rotors (1) start storing mechanical energy, charging the Stabilizing Battery up to full capacity. The said central computer informs a vacuum pump (15) to be activated also at start up to maintain a vacuum within the Stabilizing Battery's housing (16) to cut down on aerodynamic losses.

When the said ICE needs assistance from the said motor/generator connected to the said ICE, a throttle positioning sensor (18) sends a signal to the central computer (14) which controls the said motor/generator and the Stabilizing Battery. The said central computer (14) informs the said motor/generator to stop functioning like a generator and start functioning like a motor.

Then the said central computer informs all eight said stators (12) to stop functioning like a motor and starts functioning like a generator. Converting its stored mechanical energy input into electrical energy output at approximately 90% efficiency. The electrical output from the Stabilizing Battery is directly transmitted to the said motor/generator assisting the said ICE.

When electrical assistance is no longer required from the Stabilizing Battery to the said motor/generator, the said throttle positioning sensor (18) sends a signal to the said central computer (14) that controls the said motor/generator and the Stabilizing Battery. The said central computer (14) informs the said motor/generator connected to the said ICE to start functioning like a generator and stop functioning like a motor.

Then the said central computer (14) informs the Stabilizing Battery stops functioning like a generator and starts functioning like a motor, which charges up the mechanical energy within the Stabilizing Battery for the next time its stored electrical power is needed.

The advantage of receiving electrical energy from the mechanical energy stored within the said movable rotors (1), is that they can speed up and slow down with a high degree of reliability and durability.

In contrast chemical batteries have only a certain number of cycles they can be put through before they need replacement. When put through high discharge rates, the life of the chemical battery is dramatically shortened. The Stabilizing Battery outperforms the chemical battery and toxic waste is not an issue because there is no hazardous material inside.

The Stabilizing Battery's said movable rotors (1) spins much slower than conventional mechanical batteries, but its said movable rotors (1) has a greater diameter. Because most of the said movable rotors (1) mass is out at the end of the said movable rotors (1), within the said movable weights (2) the produced gyroscopic forces do not effect the handling of the motor vehicle.

Hybrid sport utility vehicle are the next likely move for the automobile manufacturers to increase fuel economy, but they have a high center of gravity.

With the Stabilizing Battery installed in the hybrid sport utility vehicle, the said central computer (14) monitors the angle of the said motor vehicle and the acceleration of the angle of the said motor vehicle from its built in gyroscope's (13) input sensors.

When the said motor vehicle is about to roll over, the said central computer (14) strategically controls each one of the 8 said stators (12) independently, informing 4 said stators to function like a generator and 4 said stators to function like a motor. Producing an internal torque within the battery housing (16), the exact opposite force that the said motor vehicle is producing and allows the vehicle to stay up right.

Once the said motor vehicle has stabilized the said central computer (14) informs the Stabilizing Battery to stop functioning like an anti-roll system and start functioning like a mechanical battery once again. This is a very important safety feature that the Stabilizing Battery offers.

### Stabilizing Battery Features

The said motor vehicles stability comes from an anti-roll device built into the Stabilizing Battery system.

When the said motor vehicle is going down the road with the Stabilizing Battery at fill charge, the said movable weights (2) are held in place by the repulsion of the permanent magnets (4) attached to the movable rotors (1) and permanent magnets (3) within the movable weights also by centrifugal force. The two said movable rotors (1) now act like one piece rotors.

When the said motor vehicle hits a bump in the road the 24 said movable weights (2) in the two said movable rotors (1) move slightly off there original center line, lessening the gyroscopic force from the two said movable rotors (1) to the said motor vehicle's chassis. The two said movable rotors (1) spin opposite each other, so that the precession motion cancels each other out.

When the 24 said movable weights (2) within the two said movable rotors (1) resets themselves back to there original center line by centrifugal force, the up and down forces are also canceled out. The battery housing (16) rides on the said soft rubber mounts (19) that are connected to the undercarriage of the said motor vehicle.

Between the 24 said movable weights (2) and the said rubber mounts (19) allow the said motor vehicle to have a smooth ride unaffected by the gyroscopic forces produced by the said movable rotors (1). The anti-roll device is very unique because it uses almost all the components that make up the Stabilizing Battery.

The built in gyroscope (13) senses that the said motor vehicle is about to over turn and the said central computer (14) informs the Stabilizing Battery to stop functioning like a mechanical battery and start functioning like an anti-roll device.

Once the said motor vehicle has been stabilized, the said central computer (14) informs the Stabilizing Battery to stop functioning like an anti-roll device and start functioning like a mechanical battery again. The Stabilizing Battery is always ready to stabilize the motor vehicle if necessary.

### Anti-roll Function

Now if the said hybrid sport utility vehicle made a hard right hand turn to avoid a collision.

The high center of gravity would cause the said motor vehicle to ride on the left wheels and the right wheels would come off the road and flip the motor vehicle over.

Wouldn't it be beneficial at that very moment the right side of the motor vehicle was to become heavier and the left side of the said motor vehicle became lighter?

This would keep the right wheels on the ground and increase the chance to recover control from the sudden turn.

This is how the anti-roll system works . . . let's call the front of the said motor vehicle 12:00 and the back 6:00 and 3:00 will be the right side and 9:00 will be the left side. Let's go over that same scenario. When the said motor vehicle makes a hard right hand turn, the high center of gravity is pushing hard on the left side of the said motor vehicle.

At that very moment the build in said gyroscope (13) which is centrally located in the said motor vehicle sends a signal to the said central computer (14) that controls the operation of the Stabilizing Battery. Now there are 8 complete, 180 degree said stators (12) 4 said stators for each said movable rotor (1). Each one of the said stators (12) is placed 45 degrees off the centerline of the two said movable rotors (1).

When the said movable rotor (1) is spinning clockwise and the said magnet (3) inside the said movable weight (2) passes the 12:00 position, the said central computer (14) that controls the Stabilizing Battery, informs the bottom said stator (12) to function like a generator. Therefore placing a physical resistance to the magnetic induction. The magnetic induction attempt's to push the said movable rotor (1) counter clockwise, also pushing the said movable weight (2) up slightly off the centerline of the said movable rotor (1) giving a “downward” force to the bottom said stator (12) from 12:00 to 6:00 centered at the 3:00 position producing electrical output.

When the same said magnet (3) inside the said movable weight (2) passes the 12:00 position spinning clockwise, the said central computer (14) that controls the Stabilizing Battery informs the said top stator (12) to function like a motor. The magnetic induction attempt's to pull the said movable rotor (1) clockwise, also pulling the said movable weight (2) up slightly off the centerline of the said movable rotor (1) producing a “downward” force to the top said stator (12) from the 12:00 to 6:00 centered at the 3:00 position. The electrical input to the top said stator (12) functioning like a motor, comes from the electrical output from the bottom said stator (12) that functions like a generator. This happen over and over when the 12 said movable weights (2) pass the 12:00 to 6:00 centered at the 3:00 position spinning clockwise.

The operation of the said movable rotor spinning counter clockwise and the 2-180 degree stators (12) centered at the 3:00 position would be the same as the clockwise spinning movable rotor (1) with the bottom said stator (12) functioning like a generator and the top said stator (12) functioning like a motor, but the timing of the said stators (12) will be in the 6:00 to 12:00 position centered at the 3:00 position.

When the said movable weights (2) with there said magnets (3) within pass the 6:00 position spinning clockwise, the said central computer (14) that controls the Stabilizing Battery informs the top said stator (12) to function like a generator. Therefore placing a physical resistance to the magnetic induction. The magnetic induction try's to push the said movable rotor (1) counter clockwise, also pushing the said movable weight (2) down slightly off there original centerline of the said movable rotor (1) giving an “upward” force to the top said stator (12) from the 6:00 to 12:00 centered at the 9:00 position producing electrical output.

When the same said magnet (3) within the said movable weight (2) passes the 6:00 position spinning clockwise, the said central computer (14) that controls the Stabilizing Battery informs the bottom said stator to function like a motor. The magnetic induction try's to pull the said movable rotor (1) clockwise, also pulling the said movable weight (2) down slightly off there original centerline of the said movable rotor (1) giving an “upward” force to the bottom said stator (12) from 6:00 to 12:00 centered at the 9:00 position. The electrical input to the bottom said stator (12) functioning like a motor, comes from the electrical output from the top said stator (12) that functioning like a generator.

The operation of the said movable rotor (1) spinning counter clockwise and the 2-180 degree stators (12) centered at the 9:00 position would be the same as the clockwise spinning movable rotor (1) with the bottom said stator (12) functioning like a motor and the top said stator (12) functioning like a generator, but the timing of the said stators (12) will be in the 12:00 to 6:00 position centered at the 9:00 position.

When the said gyroscope (13) senses that the motor vehicle has been stabilized, then the said central computer (14) deactivates the anti-roll system and the Stabilizing Battery is now activated.

What I claim as my invention is:

1. A mechanical storage battery with an anti-roll system, comprising; two identical movable rotors (1), 24 individual said movable weights (2), 24- 8-pole permanent magnets (3), 24 said 4-poled permanent magnets (4) attached to the said movable rotors (1), 24 shafts (5), 48 bearings (6), 24 said holding arms (7), 2 harmonic balancers (8), 2 main shafts (9), 4 main bearings (10), a differential unit (11), 8 complete stators (12) 180 degrees each, a gyroscope (13), a central computer (14) a vacuum pump (15), Stabilizing Battery's housing (16), a safety rim (17), a throttle positioning sensor (18), 4 rubber mounts (19)

2. A mechanical storage battery with an anti-roll system, the component of claim 1, consisting of two identical movable rotors (1), that are spun opposite each other.

3. A mechanical storage battery with an anti-roll system, the component of claim 1, within each one of the two said movable rotors (1), there are 12 individual said movable weights (2) 24 total for the 2 said movable rotors, which reduce the gyroscopic forces and allows the anti-roll system to function properly.

4. A mechanical storage battery with an anti-roll system, the component of claim 1, within each one of the 24 said movable weights (2) there is a 8-pole permanent magnet (3), each side of the said permanent magnet (3) is 4-poled, this allows the said stators (12) to interact with the said magnets (3) for proper battery and anti-roll operation, also repel against the 24 4-poled permanent magnets (4) attached to the two movable rotors (1).

5. A mechanical storage battery with an anti-roll system, the component of claim 1, wherein there are 24 said 4-poled permanent magnets (4) attached to the said movable rotors (1) facing the 24 said 8-poled permanent magnets (3) within the 24 said movable weights (2) with like poles facing each other, giving a repulsion force.

6. A mechanical storage battery with an anti-roll system, the component of claim 1, wherein the repulsion of the 24- 4-poled said permanent magnets (4) functions like a magnetic spring, holding the 24 said movable weights (2) and the 24- 8-poled permanent magnets (3) in there proper said magnets (3)—stators (12) placement for the proper Stabilizing Battery operation.

7. A mechanical storage battery with an anti-roll system, the component of claim 1, wherein there are 2 bearings (6) that are placed within each one of the 24 said movable weights (2).

8. A mechanical storage battery with an anti-roll system, the component of claim 1, wherein there are 24 shafts (5) that ride on the 48 said bearings (6), connected to the 24 holding arms (7), 12 said holding arms (7) per each one of the 2 said movable rotors (1), which support the 24 said movable weights (2).

9. A mechanical storage battery with an anti-roll system, the component of claim 1, wherein there are 2 harmonic balancers (8) 1 each placed within the center of the 2 said movable rotors (1), which increases the operational life of the said internal components.

10. A mechanical storage battery with an anti-roll system, the component of claim 1, wherein there are 2 main shafts (9) connected to each one of the 2 said movable rotors (1).

11. A mechanical storage battery with an anti-roll system, the component of claim 1, wherein the 2 said main shafts (9) are supported by 4 main bearings (10).

12. A mechanical storage battery with an anti-roll system, the component of claim 1, wherein connected to the 2 said main shafts (9) there is a differential unit (11) that keeps the 2 said movable rotors (1) at its proper timing.

13. A mechanical storage battery with an anti-roll system, the component of claim 1, wherein next to the 24 said movable weights (2) there are 8 complete stators (12) 180 degrees each, placed 45 degrees off the centerline of the 2 said movable rotors (1), all 8 of the said stators (12) can be independently controlled by the said central computer (14). This said stator (12) placement works in unison with the movable weights (2) and allows the said mechanical battery and the said anti-roll system to operate properly.

14. A mechanical storage battery with an anti-roll system, the component of claim 1, wherein there is a gyroscope (13) built into the said central computer (14) with its sensors directly connected to the said central computer (14). The gyroscope is centrally located in the said motor vehicle, this allows the central computer (14) to fully monitor the angle of lean and accelerated angle of lean, of the motor vehicle at all times.

15. A mechanical storage battery with an anti-roll system, the component of claim 1, wherein there is a said central computer (14) that fully controls all the Stabilizing Battery's functions, the said central computer sets the operating speed of the said movable rotors (1), by controlling all 8 of the said stators (12), also deciding when each one of the said stators (12) are to function like a generator or when each one of the said stators are to function like a motor. Also controls and monitors the function of the motor/generator connected to the ICE, vacuum pump and the built in gyroscope (13).

16. A mechanical storage battery with an anti-roll system, the component of claim 1, wherein there is a said vacuum pump (15) inside the Stabilizing Battery's housing (16), that is activated by the central computer (14) at the start up of the said motor vehicle to maintain a vacuum in the said Stabilizing Battery housing (16), which reduces the aerodynamic losses.

17. A mechanical storage battery with an anti-roll system, the component of claim 1, wherein there is a said Stabilizing Battery housing (16) that supports all the said internals components in there proper placement.

18. A mechanical storage battery with an anti-roll system, the component of claim 1, wherein on the outer part of the Stabilizing Battery there is a safety rim (17) that supports all the 8 said stators (12) in there proper place and partially enclosing all 24 of the said movable weights (2) within the 2 said movable rotors (1). Which help contain the internal components, if a motor vehicle accident occurs or a mechanical problem.

19. A mechanical storage battery with an anti-roll system, the component of claim 1, wherein there is a throttle positioning sensor (18) with its sensor directly connected to the said central computer (14). That informs the said motor/generator connected to the said ICE when to function like a motor and when to function like a generator. Also when the Stabilizing Battery is to function like a generator and when to function like a motor.

20. A mechanical storage battery with an anti-roll system, the component of claim 1, wherein there are 4 rubber mounts (19) each one attaches to the said Stabilizing Battery housing (16), that mounts to the undercarriage of the said motor vehicle.

21. A mechanical storage battery with an unique built in anti-roll system, wherein the said mechanical storage battery performs like a conventional mechanical battery in a motor vehicle but when the said central computer (14) receives information from the said gyroscope (13) that the said motor vehicle has past its said central computer (14) programmed tolerated angle of lean or accelerated angle of lean or both, then the said central computer (14) has the said mechanical storage battery stop functioning like the said mechanical storage battery and starts functioning like the said anti-roll system. Converting its stored mechanical energy into electrical energy and produces a torque action in the opposite direction the said motor vehicle is producing.

22. A mechanical storage battery with an unique built in anti-roll system of claim 21, wherein when the said central computer (14) receives information from the said gyroscope (13) that the said vehicle has stabilized then the said anti-roll system stops functioning and the said mechanical storage battery functions like a said battery once again.

23. A mechanical storage battery with an unique built in anti-roll system of claim 21, wherein when the said motor vehicle is about to roll over from a quick maneuver or going too fast in a turn. Then the information from the said gyroscope (13) is transmitted to the said central computer (14). The said central computer (14) informs all of the 8 said stators (12) to function like an anti-roll system.

24. A mechanical storage battery with an unique built in anti-roll system of claim 21, wherein there are eight said stators (12) four said stators (12) per each 1 of the 2 said movable rotors (1), each one of the said stators (12) are 180 degrees each, when the said motor vehicle is about to over turn from the right side (passenger side in the USA), with its right side wheels becoming lighter and over turning to the left side (driver side in the USA) with its left side wheels becoming heavier. The two 180 degree right side said stators (12) placed above the said movable rotors (1) function like a motor and the two 180 degree right side said stators (12) placed below the said movable rotors (1) function like a generator. The magnetic induction interacts with the said 8- pole permanent magnets (3), said movable weights (2) and the said movable rotors (1) to produce a “downward” force to the right side of the said motor vehicle (passenger side in the USA).The electrical input to the top 2- 180 degree said stators (12) functioning like a motor comes from the electrical output from the bottom 2-180 degree said stators (12) functioning like a generator.

25. A mechanical storage battery with an unique built in anti-roll system of claim 21, wherein there are eight said stators (12) four said stators (12) per each 1 of the 2 said movable rotors (1), each one of the said stators (12) are 180 degrees each, when the said motor vehicle is about to over turn from the right side (passenger side in the USA), with its right side wheels becoming lighter and over turning to the left side (driver side in the USA) with its left side wheels becoming heavier. The two 180 degree left side said stators (12) placed above the said movable rotors (1) functions like a generator and the two 180 degree said stators (12) placed below the said movable rotors (1) functions like a motor. The magnetic induction interacts with the said 8- pole permanent magnets (3), said movable weights (2) and the said movable rotors (1) to produce a “upward” force to the left side of the motor vehicle (driver side in the USA).The electrical input to the bottom two 180 degree said stators (12) functioning like a motor comes from the electrical output from the top 2- 180 degree said stators (12) functioning like a generator.

26. A mechanical storage battery with an unique built in anti-roll system of claim 21, wherein there are 8 said stators (12) 4 said stators (12) per each 1 of the 2 said movable rotors (1), each one of the said stators (12) are 180 degrees each, when the said motor vehicle is about to over turn from the left side (driver side in the USA), with its left side wheels becoming lighter and over turning to the right side (passengers side in the USA) with its right side wheels becoming heavier. The two 180 degree left side said stators (12) placed above the said movable rotors (1) function like a motor and the two 180 degree left side said stators (12) placed below the said movable rotors (1) function like a generator. The magnetic induction interacts with the said 8- pole permanent magnets (3), said movable weights (2) and movable rotors (1) to produce a “downward” force to the left side of the said motor vehicle (driver side in the USA). The electrical input to the left side top said stators (12) functioning like a motor comes from the electrical output from the left side bottom said stators (12) functioning like a generator.

27. A mechanical storage battery with an unique built in anti-roll system of claim 21, wherein there are 8 said stators (12) 4 said stators (12) per each 1 of the 2 said movable rotors (1), each said stators (12) are 180 degrees each, when the said motor vehicle is about to over turn from the left side (drivers side in the USA), with its left side wheels becoming lighter and over turning to the right side (passengers side in the USA) with its right side wheels becoming heavier. The two 180 degree right side said stators (12) placed above the said movable rotors (1) function like a generator and the two 180 degree right side said stators (12) placed below the said movable rotors (1) function like a motor. The magnetic induction interacts with the said 8- pole permanent magnets (3), said movable weights (2) and movable rotors (1) to produce a “upward” force to the right side of the motor vehicle (passenger side in the USA).The electrical input to the right side bottom said stators (12) functioning like a motor comes from the electrical output from the right side top stators (12) functioning like a generator.
